(19) United States
(12) Patent Application Publication
(10) Pub. No.: US 2026/0003685 A1
(43) Pub. Date: Jan. 1, 2026

(54) PLACEMENT OF GRAPH-BASED WORKLOAD TASKS WITH OPTIMAL INFRASTRUCTURE SELECTION AND LINK STATE ASSESSMENTS

(71) Applicant: Dell Products L.P., Round Rock, TX (US)

(72) Inventors: Rômulo Teixeira de Abreu Pinho, Niterói (BR); Paulo de Figueiredo Pires, Niterói (BR); Eduardo Vera Sousa, Niterói (BR); Vinicius Michel Gottin, Rio de Janeiro (BR); Alessandro Aparecido Milan, Poços de Caldas (BR); Aldo Eliades Fernández Pérez, Rio de Janeiro (BR)

(21) Appl. No.: 18/758,232

(22) Filed: Jun. 28, 2024

(51) Int. Cl. G06F 9/50; G06F 16/33; G06F 16/901

(52) U.S. Cl. CPC G06F 9/5027; G06F 16/3347; G06F 16/9024

(57) ABSTRACT

One example method includes maintaining a database of past executions of graph-based workloads and respective infrastructure graphs where the graph-based workloads were executed, obtaining a graph embedding of a new graph-based workload and searching for similar graph-based workloads in the database, retrieving each similar graph-based workload from the database, where each of the similar graph-based workloads is associated with a respective infrastructure subgraph corresponding to where that similar graph-based workload was executed, searching a large graph-based infrastructure topology for infrastructure subgraphs that are similar to the infrastructure subgraphs retrieved from the database, and retrieving a group of infrastructure subgraphs that collectively define a set of candidate nodes to run the new graph-based workload, filtering and ranking the set of candidate nodes according to a respective likelihood that the candidate nodes will satisfy requirements of the new graph-based workload, and assigning the new graph-based workload to one of the candidate nodes.

### COPYRIGHT AND MASK WORK NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### TECHNOLOGICAL FIELD OF THE DISCLOSURE

Embodiments disclosed herein generally relate to workload placement in an infrastructure. More particularly, at least some embodiments relate to systems, hardware, software, computer-readable media, and methods, for placement of workloads in an infrastructure, taking into account real-time infrastructure parameters and the state of nodes in a topology where the workloads are to be placed.

### BACKGROUND

Optimal resource allocation is a well-known problem in computational infrastructure management, and particularly important for as-a-service (aaS) models. While resource usage of workloads is often very dynamic, determining where to start the execution that is, the placement, of a workload in the available infrastructure is important to satisfy service level agreements (SLA). An infrastructure topology can be represented as a graph. Similarly, modern workloads may be implemented via components, such as microservices, that run independently and communicate with each other to accomplish various tasks. Such workloads can also be represented as graphs. While these representations tend to increase the robustness and scalability of workloads, their non-monolithic aspect creates a challenge for workload placement.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 discloses aspects of several executions of a graph-based workload, W, on graph-based infrastructures, Iᵢ, that are sub-graphs of a large infrastructure topology graph II.

FIG. 2 discloses aspects of representations of workload and infrastructure, and their relationships, as a meta-graph, which is stored in a GDBMS (graph database).

FIG. 3 discloses an example workload placement algorithm.

FIG. 4 discloses an example simplification of a representation and storage of workload and infrastructure graphs in the historical database of past workload executions.

FIG. 5 discloses an example method to represent resource variables in a Euclidian space so that the relationship between workload requirements and resources available in candidates can be assessed in vectorial form.

FIG. 6 discloses an example representation matrix of each resource dimension allocation for/workload tasks and J candidate nodes.

FIG. 7 discloses an example workload placement algorithm according to one embodiment.

FIG. 8 discloses aspects of an example method according to one embodiment.

FIG. 9 discloses an example computing entity configured and operable to perform any of the disclosed methods, processes, and operations.

### DETAILED DESCRIPTION OF SOME EXAMPLE EMBODIMENTS

Embodiments disclosed herein generally relate to workload placement in an infrastructure. More particularly, at least some embodiments relate to systems, hardware, software, computer-readable media, and methods, for placement of workloads in an infrastructure, taking into account real-time infrastructure parameters and the state of nodes in a topology where the workloads are to be placed.

One example embodiment comprises a method for placement of a workload in a computing infrastructure. The workload may be executed, for example, by a group of microservices. The microservices may run in a cloud computing infrastructure and/or in an on-premises computing environment.

In one embodiment, such a method may comprise the operations: maintaining, in a historical database, past executions of different workload graphs and the respective infrastructure graphs where the workloads executed-both the workload and the infrastructure may be represented by graph embeddings of their topology; when placing a new graph-based workload on a large graph-based infrastructure topology, obtain the graph embedding of the workload and search for similar workloads in the historical database—the similarity search may be implemented using a cosine distance between embedded vectors; retrieving each similar workload retrieved from the database is associated with an infrastructure subgraph corresponding to where the workload was executed—the set of infrastructure subgraphs represents the graph topologies that are likely to satisfy the requirements of the new workload; searching, across the large graph-based infrastructure topology, subgraphs that are like those retrieved from the historical database—the retrieved subgraphs form the set of candidates to run the workload; using live telemetry data from the infrastructure, filter and rank the set of candidates according to the likelihood that they will satisfy the requirements of the new workload, using a “lie-within” relationship; and, in the order of the ranked candidates, try to assign workload tasks to infrastructure subgraph nodes by: assessing the health status of the nodes and of the network links between them; and assigning tasks to nodes using a “northwest corner” algorithm for capacity planning.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect an embodiment is that an embodiment may allocate workload task onto candidate nodes of a computing infrastructure. An embodiment may take into account real-time infrastructure parameters when placing workloads. An embodiment may take into account the state of the nodes of an infrastructure when placing workloads. Various other advantages of one or more example embodiments will be apparent from this disclosure.

### A. REFERENCES

The references listed below are incorporate herein in their respective entireties, and

may be referred to throughout this disclosure.
[1] U.S. patent application Ser. No. 17/505,820, entitled SYSTEMS AND METHODS FOR WORKLOAD PLACEMENT BASED ON SUBGRAPH SIMILARITY, and filed Oct. 20, 2021.
[2] R. (Zhitao) Ying, Z. Lou, J. You, C. Wen, A. Canedo and J. Leskovec, “Neural Subgraph Matching,” https://arxiv.org/abs/2007.03092, 2020.
[3] HILLIER, F.; LEBERMAN, G. J. Introduction to Operational Research, 9th edition. Mc Graw-Hill, 1991, p. 299.

### B. CONTEXT FOR AN EXAMPLE EMBODIMENT

The following is a discussion of an example context for an embodiment. This discussion is not intended to limit the scope of the claims or this disclosure, or the applicability of the embodiments, in any way.

The work in [1] is concerned with the problem of allocating a graph-based workload on a graph-based infrastructure. In more detail, an embodiment may relate to a data representation, storage, and querying framework to tackle the problem of SLA-oriented placement of graph-based workloads on graph-based infrastructure topologies. Such framework, an example of which is disclosed in [1], leverages graph embeddings, graph databases, sub-graph matching, and prediction mechanisms to choose which piece, that is, sub-graph, of a large infrastructure is the best candidate to run a workload under given SLA constraints.

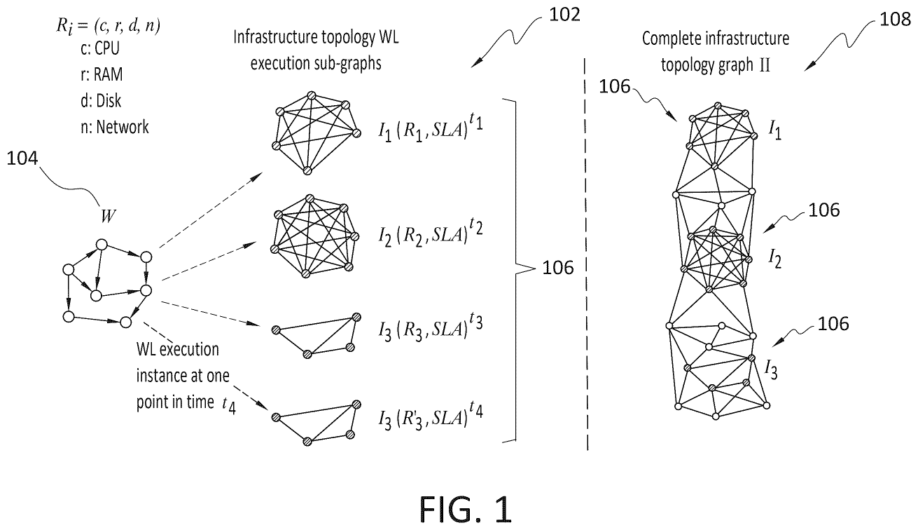

From a data representation perspective, the approach in [1] involves representing workloads and infrastructure topologies as graphs that not only encode the relationship between components of the workloads or infrastructure elements, but also carry information about resource usage patterns and their relationships with SLAs, as illustrated in FIG. 1. Particularly, the example of FIG. 1 discloses several executions 102 of a graph-based workload W 104 on various graph-based infrastructures, lᵢ 106, that are sub-graphs of a large infrastructure topology graph/108. Each execution has an associated resource usage pattern Rᵢ encoded in CPU, RAM, Disk, and Network signatures. Each execution is also related to SLA metrics, such as execution time, and a representative timestamp tᵢ.

From a storage perspective, the approach involves leveraging graph databases (GDBMs) to record the representations disclosed in FIG. 1. Each workload and each infrastructure graph may be composed of nodes and edges that represent individual components and their relationships, respectively.

In the case of workloads, components, indicated as nodes, typically represent tasks, and relationships, indicated as edges, represent dependencies between tasks. In some frameworks, datasets are also represented as nodes, and edges additionally define which tasks produce/consume which datasets. This is the case in dataflows in parallel processing engines such as Spark, and in workflow management systems. This approach may be applicable to any such representation.

In infrastructure graphs, relationships, indicated by respective edges, typically represent the physical connection between computational resource components, indicated by respective nodes. In an embodiment, a component may configure a processing node, linked to other processing nodes in a cluster, with the cluster as part of a larger datacenter.

Since components are elements of computation themselves, each node of the graphs is also associated with attributes that related to resource usage patterns and signatures. In the case of workload graphs, such information reflects the typical resource usage of each component. In infrastructure graphs, it reflects the overall resource usage, including the resource consumption of workload instance while it executed on the infrastructure graph.

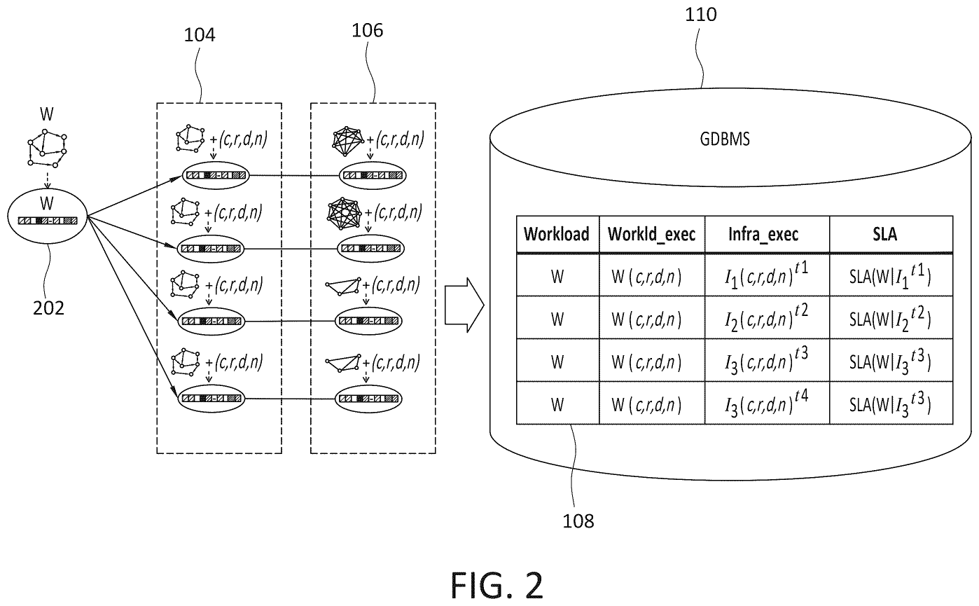

In the approach disclosed in [1], graph embedding mechanisms may be employed to encode both workload and infrastructure representations, along with resource usage metrics and SLAs. Graph embedding transforms nodes and edges of a graph into vectorial information of lower dimensionality in such a way to preserve the original graph information with as little data as possible. This is illustrated in FIG. 2. Particularly, FIG. 2 discloses an example workload 202 and infrastructure 104, and their relationships 106, as a meta-graph 108, which itself is stored in a GDBMS 110. Note that each node also stores a resource usage signature derived from the encoded graphs.

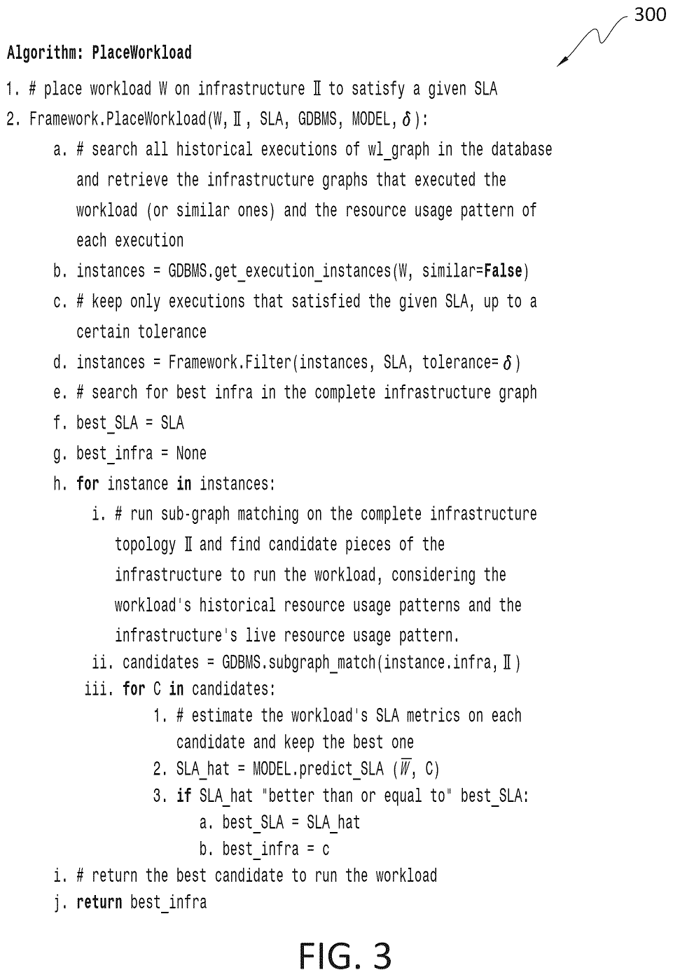

The graph database may be used in queries whose objective is to allow a new instance of a known workload to be executed on a piece of infrastructure that would be similar to one that had been used in past executions of the workload and that satisfied a similar SLA. For this, the GDBM query engine leverages the graph embeddings and graph similarity searches to locate the given workload in the database and to retrieve candidate infrastructure graphs to run such workload. The method then traverses the list of candidates in search for the one that likely satisfies the SLA according to a prediction model. An example placement algorithm 300, as disclosed in [1], is set forth in FIG. 3. In the example approach of FIG. 3, after the execution of the workload on the selected infrastructure subgraph, the respective embedded representations may be added to the historical graph database for future searches.

### C. OVERVIEW OF ASPECTS OF ONE EMBODIMENT

Reference [1] addressed the problem of graph-based workload placement on a graph-based infrastructure topology to satisfy a given SLA. The approach there is based on solving a subgraph matching problem that found candidate topology subgraphs for running the given workload. However, that approach does not address how workload tasks, or workload graph nodes, should be allocated onto the infrastructure candidate nodes.

On the other hand, an example embodiment disclosed herein may improve upon, and such as by adding to, the approach disclosed in [1] to allocate workload tasks on a selected candidate graph for the allocation, taking into account real-time infrastructure parameters and the state topology nodes. One such example embodiment of a workload placement method may comprise the following operations:
1. keeping, in a historical database, past executions of different workload graphs and the respective infrastructure graphs where the workloads executed-both the workload and the infrastructure are represented by graph embeddings of their topology;
2. when placing a new graph-based workload on a large graph-based infrastructure topology, obtaining the graph embedding of the workload and search for similar workloads in the historical database—in an embodiment, the similarity search is implemented by way of a cosine distance between embedded vectors;
3. associating each similar workload retrieved from the with an infrastructure subgraph corresponding to where the workload was executed—in an embodiment, the set of infrastructure subgraphs represents the graph topologies that are likely to satisfy the requirements of the new workload;
4. searching, across the large graph-based infrastructure topology, subgraphs that are like those retrieved from the historical database—in an embodiment, the retrieved subgraphs form the set of candidates to run the workload;
5. using live telemetry data from the infrastructure, filter and rank the set of candidates according to the likelihood that they will satisfy the requirements of the new workload, using a “lie-within” relationship; and
6. in the order of the ranked candidates, attempting to assign workload tasks to infrastructure subgraph nodes by: (1) assessing the health status of the nodes and of the network links between them; and (2) assigning tasks to nodes with a “northwest corner” algorithm for capacity planning.

As disclosed herein, an embodiment may possess various useful features and aspects, although no embodiment is required to possess any of such features or aspects. The following examples are illustrative. An embodiment may provide the decoupling of topology and resource variables in the data representation and graph embeddings. An embodiment may comprise a greedy approach for the search of candidate infrastructure subgraphs for the placement, where the search is based only on graph topologies and the candidate selection is done a posteriori using real-time telemetry from candidate nodes, using a novel candidate filtering and ranking method based on a “lie-within” relationship. An embodiment may implement assessment of node and network health before assigning tasks to candidate nodes. As a final example, an embodiment may implement assignment of workload tasks to infrastructure nodes via a “northwest corner” algorithm, or other suitable algorithm, for capacity planning.

### D. DETAILED DISCUSSION OF ASPECTS OF ONE EMBODIMENT

Aspects of one embodiment concern (1) how workload and infrastructure graphs are embedded, (2) how the candidate infrastructure subgraphs are obtained and processed, and (3) how the workload tasks are assigned to nodes of the selected infrastructure subgraph.

### D.1 Decoupling Infrastructure Topology and Resource Usage

In [1], there is disclosed a graph embedding mechanism to encode a workload topology along with its resource usage telemetry and another one to encode an infrastructure subgraph topology along with the overall resource usage telemetry when the workload is executed on it. In some circumstances, this may create a cold-start issue when a new workload with similar characteristics would be executed, since no resource usage telemetry would be available for it. To circumvent that, another embedding of the topology alone was necessary to perform database queries. Furthermore, embedding the resource usage telemetry of the infrastructure along with its topology created unnecessary complexity for the subgraph matching step, as will become clear shortly.

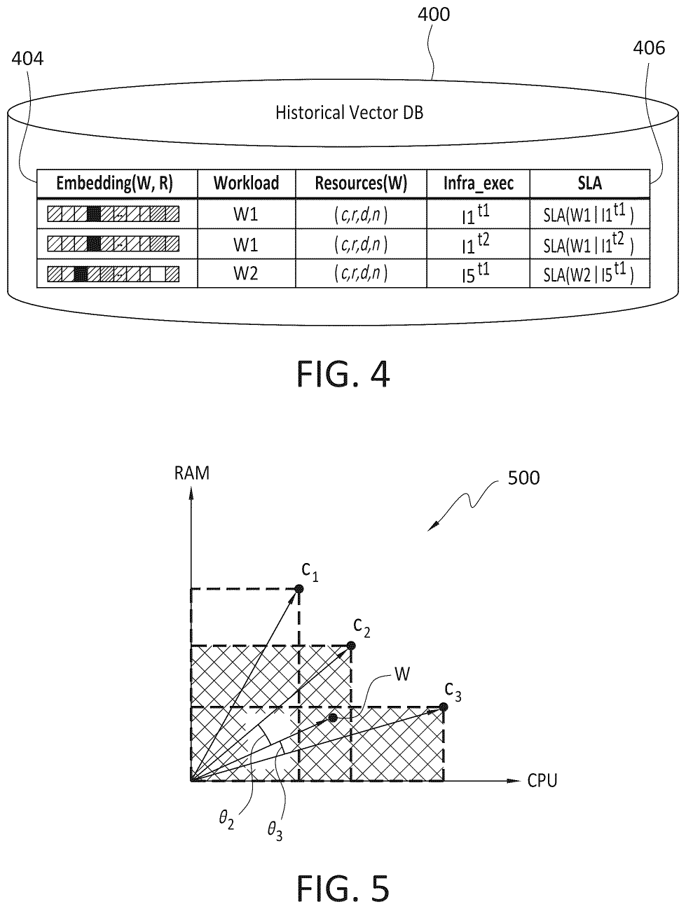

With the foregoing in view, one embodiment comprises a simplification of the data representation adopted in [1]. In this regard, FIG. 4 discloses a simplification of the representation and storage of workload and infrastructure graphs in a historical database 400 of past workload executions. In particular, a workload topology (W) is embedded along with its resource requirements (R), as shown at 404. That is, an embodiment may assume the placement algorithm already knows how many resources the workload needs. This may solve the cold-start issue and eliminate the need for an additional embedding of the workload topology. Second, an embodiment may separate resource usage information from the topology of infrastructure subgraphs and keep only the infrastructure subgraphs in the database. This makes the subgraph search and ranking much simpler. Finally, SLA measures 406 of each execution, such as execution time, and queueing time, for example, may be kept as metadata in the historical database 400.

### D.2 Infrastructure Search and Ranking

One embodiment may employ the same subgraph search algorithm [2] used in [1] to speed up the process. However, the approach according to one embodiment enables subgraph searches across the target infrastructure graph to return more candidates, since only the topology is used. Those candidates may then be filtered and ranked in a process that assesses their real-time resource usage relative to the resources requested by the workload.

For the actual assessment of resource consumption, one embodiment comprises a mechanism where the resource variables, such as CPU (central processing unit), RAM (random access memory), or disk usage, for example, form a Euclidean space. In order to filter out candidates that are unlikely to satisfy the resource requirements of the workload to be placed, an embodiment may compare the variables representing the requirements of the workload with the variables representing the amount of resources available on the candidates.

In an embodiment, such a comparison process may proceed as follows. First, resource requirements of each task of the workload may be aggregated, such as using a harmonic mean, into an average requirement, w. Similarly, the available resources on each node of the candidates are also aggregated, using the harmonic mean, into an average representation, cᵢ. Using such representations, an embodiment may both filter out candidates that are unlikely to satisfy the requirements and rank the remaining candidates, as illustrated in the example of FIG. 5.

Particularly, FIG. 5 discloses an example approach, according to one embodiment, for representation of variables in a Euclidian space so that the relationship between workload requirements and resources available in candidates can be assessed in vectorial form.

In more detail, and by way of illustration and not limitation, FIG. 5 discloses RAM and CPU as examples of two resource dimensions in a Euclidean space 500. The vectors c₁, c₂, and c₃ represent the mean resource availability of three candidate infrastructure subgraphs retrieved from the historical database, such as the historical database 400 disclosed in FIG. 4 for example. The vector w represents the mean resource requirements of the graph that corresponds to the workload. Since all coordinates are positive, all vectors fall in the first quadrant of the Euclidean space. For a candidate to likely satisfy the resource requirements of the workload, the vector w must lie completely within, that is, ‘lie within,’ the subspace formed by the candidate vector, that is, the shaded areas of FIG. 5. As a result, in the example case of FIGS. 5, c₂ and c₃ qualify as candidates, and c₁ will be removed from consideration as a possible candidate. In an embodiment, this “lie-within” relationship may be mathematically defined with the following equation:

$$LW = ‖ max ( 0 , w - ( {c}_{i} + tol ) ) ‖ = 0$$

Namely, if w lies within the subspace formed by cₗ, plus a tolerance ‘tol’, all coordinates of the subtraction in the equation will be less than zero, resulting in LW=0. An embodiment May employ this lie-within relationship from the “left-and-below” margin loss employed in [2] for the problem of subgraph matching, and such embodiment may add a tolerance term tol to that lie-within relationship, where the tolerance term is a problem-dependent hyperparameter.

Now that c₂ and c₃ are identified as constituting the candidate set, the next step is how to rank those candidates relative to their respective likelihood of satisfying the requirements of the workload. With the vector representations, such likelihood can be represented by the cosine distance between the vectors. That is,

$$cos {θ}_{i} = \frac{〈 w , {c}_{i} 〉}{‖ w ‖ \cdot ‖ {c}_{i} ‖}$$

In the example of FIG. 5, c₃ would be ranked higher than c₂ because the angle θ₃ is smaller than the angle θ₂ and, by definition, has a higher cosine distance value.

### D.3 Task Assignment

After filtering and ranking the candidate infrastructure subgraphs, an embodiment may assign the workload tasks to the nodes of the selected candidates. Note that, at this point, the candidates were selected based only on mean resource requirements (workload perspective) and availability (candidates). For the workload to be placed on a candidate, however, per-node resource availability needs to be assessed, along with the health status of the nodes. To do this, in one embodiment, the first step is to check, for each candidate according to the rank:
1. whether the nodes are up; and
2. whether links between nodes are up and have the required bandwidth available.
   These checks may eliminate a candidate entirely, being another filtering step of the workload placement process.

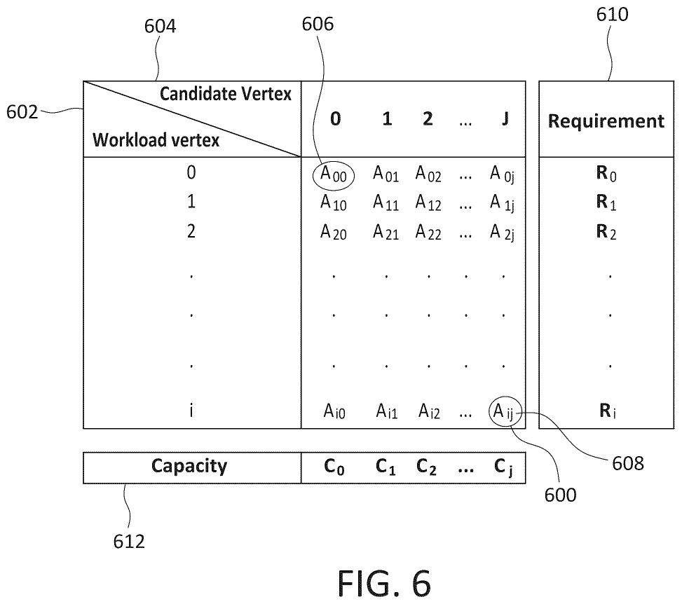

Once a candidate passes the checks, an embodiment may employ, for example, a kind of bin-packing heuristic to assign the tasks to the nodes. With reference now to the example of FIG. 6, there is disclosed a representation matrix 600 of each resource dimension allocation for/workload tasks and J candidate nodes. The assignment of the tasks to the nodes may employ a technique called “northwest corner,” which is disclosed in [3], and operates as follows:
1. One matrix l×J is constructed for each resource dimension, where l is equal to the number of workload vertices 602, that is, the number of workload tasks, and j is equal to the number of candidate vertices 604, that is, the number of the candidate nodes. Each column j∈J has its own available node capacity Cj and each row i∈I has its own task requirement Rᵢ. Each cell A_{i,j} represents the resource allocation to the respective candidate node j, as denoted in FIG. 6.
2. The task allocation follows from top-left, i.e. cell A₀₀ 606, to bottom-right, cell A_{i,j} 608, and considers all resource dimensions at once. For each resource dimension, such as RAM, CPU, and disk, for example, the task requirement Rᵢ 610 is compared with the available node capacity Cⱼ 612 regarding one of the following conditions:
   2.1 If Rᵢ<Cⱼ in all resource dimensions, then Aᵢⱼ=Rᵢ and the available node capacity is updated, following Cj′=Cⱼ−Aᵢⱼ. As requirement Rᵢ is allocated to node j, the next task with requirement Rᵢ₊₁ will be compared with the available resource capacity of Cⱼ′.
   2.2 If Rᵢ=Cⱼ, then Aᵢⱼ=Rᵢ and the available node capacity will equal 0. The next task with requirement Rᵢ₊₁ will be compared with the available resource capacity of Cⱼ₊₁.
   2.3 If Rᵢ>Cⱼ, then Aᵢⱼ=0 and the task requirement is compared with the available resource capacity Cⱼ+1.
      Step number 2 is performed until the last task requirement is allocated to any node of the candidate infrastructure subgraph.

### D.4 Placing the Workload

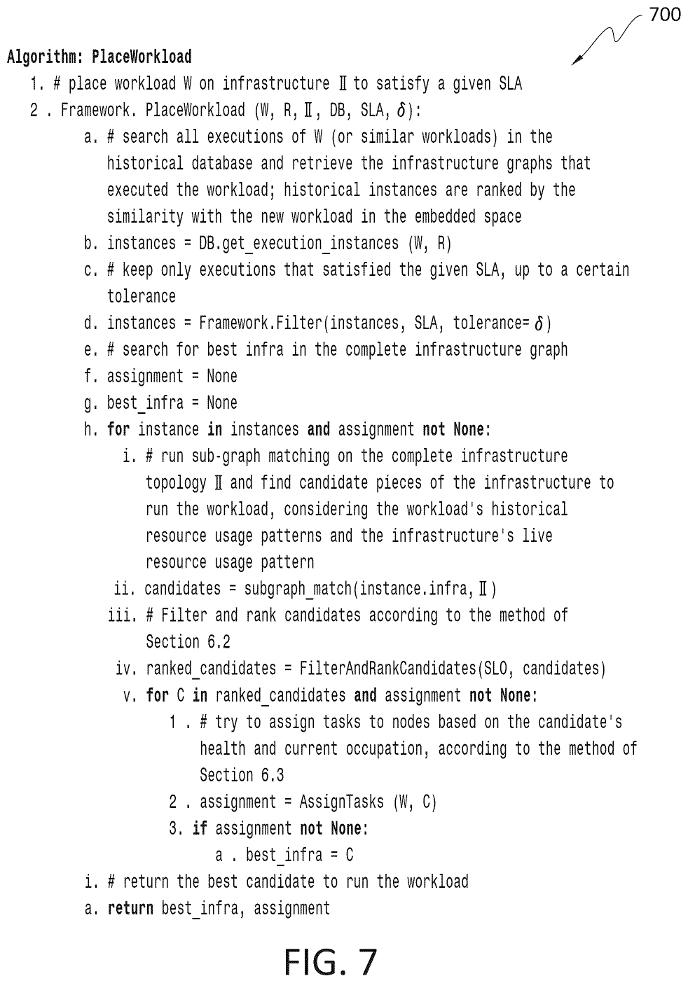

With all information in the historical database and the methods in place, an embodiment is ready to run the placement algorithm with a new workload W on the infrastructure topology II. A focus here is on how the placement algorithm queries the data in the database, finds candidate infrastructures to run the workload and rank them based on the likelihood of satisfying the workloads requirements. The details of one example workload placement algorithm 700, according to one embodiment, are disclosed in FIG. 7.

As seen in line 2 of the example algorithm 700, the algorithm 700 receives, as input, a workload graph, W, its resource requirements, R, a large infrastructure topology graph, II, an instance of the connection with the historical database, DB, and the SLA to be satisfied. In one embodiment, the algorithm 700 may optionally receive an additional argument 0≤δ≤1 that determines a tolerance for considering previous executions as feasible for the given SLA constraints, with a default value of zero.

The first step of the algorithm 700, in line 2.b, is to search the DB for all past executions of W. The function get_execution_instances encodes the W topology and resource requirements using the graph embedding procedure disclosed earlier herein, and searches the encoded representation of the database. In this way, the search performed by the algorithm 700 tends to be more efficient than doing graph matching, since similarity can be measured with simple distance metrics relative to the vectorial representations of the graphs, using, for example, distance metrics such as Euclidian distance, or cosine distance. The function get_execution_instances returns all execution instances of W found in the database, as tuples {Wᵢ, Rᵢ, Iᵢ, SLAᵢ}.

It is noted that the search in the database may return workloads similar, or equal, to W, also taking into account the resource requirements associated with each workload retrieved. This may enable one embodiment to still be able to place W by assuming that workload graphs with similar topology and similar resource requirements will tend to run in similar ways. However, this is not always true, but may nonetheless provide better results than random guesses as to the placement of W, and may be more efficient than using more traditional graph heuristics to find a good candidate to run the workload.

The instances returned by the query will be used in a filtering mechanism implemented by an embodiment of the algorithm 700, executed in step 2.d. A role of the filtering mechanism is to simply traverse the workload execution instances, and remove those whose SLA metrics do not satisfy the SLA constraints provided to the algorithm 700. This is where the parameter δ mentioned above is employed. The parameter acts as a tolerance to allow the selection of infrastructure graphs that violated the given SLA up to a certain extent. For example, if δ=1.0, no infrastructure graph is filtered, and all past executions of W are kept. For 0≤δ<1, executions that satisfied or violated the SLA up to δ*100% are kept. If δ=0 (the default value) only the executions that strictly satisfied the SLA are kept.

The rest of the algorithm 700 handles the workload placement itself. For each remaining execution instance of W after filtering, the algorithm first searches, in the complete topology infrastructure graph, II, a sub-graph that matches the infrastructure associated with that execution instance of W (line 2.h.ii). This is the point where one embodiment may leverage the efficient sub-graph matching algorithm proposed in [2].

The sub-graph matching algorithm retrieves a list of candidates to execute W for each infrastructure sub-graph associated with one of its past execution instances. The list of candidates is filtered and ranked according to the method disclosed earlier herein. The placement is then tried on the list of ranked candidates until an assignment, according to the method disclosed earlier herein, is successful or the list of candidates is completed.

Finally, the infrastructure sub-graph returned by the placement algorithm 700 is used for the execution of W. Once the execution of the workload ends, new data is added to the DB according to the data. In this way, an embodiment will tend to improve its operation over time.

### E. EXAMPLE METHODS

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

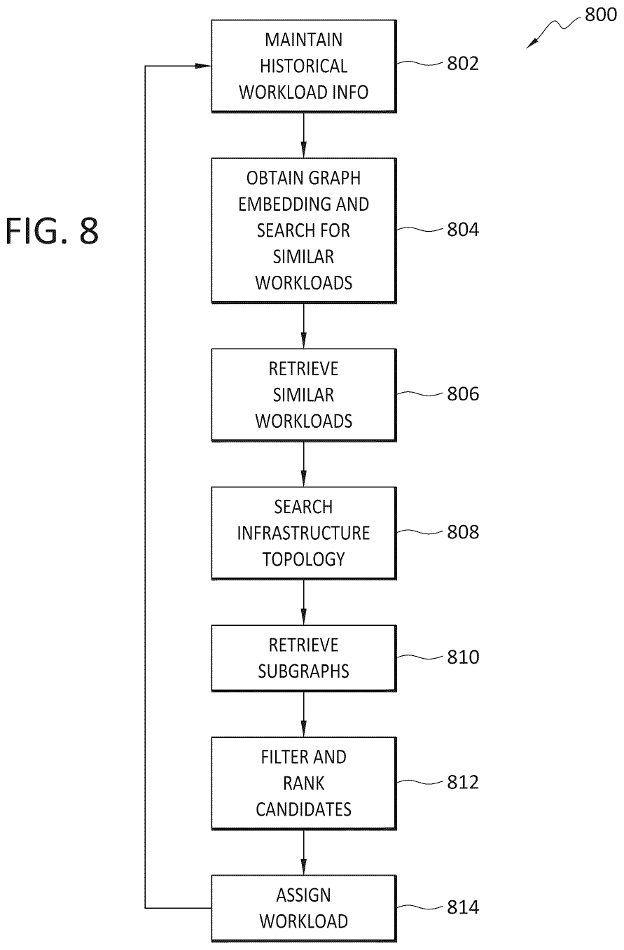

Directing attention now to FIG. 8, a method 800 according to one embodiment is disclosed. In one embodiment, the method 800 may be performed in whole or in part at any site where one or more microservices are hosted, such as a cloud computing site for example. In an embodiment, the method 800 may be performed/provided, as-a-Service, for one or more clients or subscribers. In an embodiment, the method 800 may be performed on-site at the premises of a business, or other, entity. These are provide by way of example, and the scope of this disclosure and the scope any claims presented in this case are not limited to any particular type or form of implementation of the method 800 or any other embodiments.

The example method 800 may begin with the establishment and maintenance 802 of a historical database that stores past executions of different workload graphs and the respective infrastructure graphs where those workloads executed. Both the workload and the infrastructure may be represented by graph embeddings of their topology, which may be stored in the historical database.

Next, when there is a need to place a new graph-based workload on a large graph-based infrastructure topology, the method 800 may obtain 804 the graph embedding of the workload and search for similar workloads, that is, workloads similar to the new graph-based workload, in the historical database. In one embodiment, this similarity search may be implemented using a cosine distance between embedded vectors.

Any similar workloads identified 804 may then be retrieved 806. Each similar workload retrieved 806 from the database may be associated with a respective infrastructure subgraph corresponding to where the workload was executed. In an embodiment, the set of infrastructure subgraphs represents the graph topologies that are likely to satisfy the requirements of the new workload.

Next, a search may be performed 808 across the large graph-based infrastructure topology for subgraphs that are like those retrieved from the historical database. The subgraphs identified in the search 808 may be retrieved 810 to form a set of candidates to run the workload. Using live telemetry data from the infrastructure, the set of candidates maybe filtered and ranked 812, according to the likelihood that they will satisfy the requirements of the new workload, using a “lie-within” relationship.

Finally, and based on the order of the ranked candidates, one or more attempts may be made to assign workload tasks 814 to infrastructure subgraph nodes. As part of the attempted assignment of the workload tasks 814, the health status of the candidate nodes, and of the network links between them, may be assessed. In one embodiment, assignment of the tasks to nodes may be performed using a “northwest corner” algorithm for capacity planning.

After the workload tasks have been successfully assigned 814 to respective nodes, the historical database may be updated 802 to include the identity of those tasks, and the respective infrastructure nodes at which the tasks were performed.

### F. FURTHER EXAMPLE EMBODIMENTS

Following are some further example embodiments. These are presented only by way of example and are not intended to limit the scope of this disclosure or the claims in any way.

Embodiment 1. A method, comprising: maintaining a database of past executions of graph-based workloads and respective infrastructure graphs where the graph-based workloads were executed; obtaining a graph embedding of a new graph-based workload and searching for similar graph-based workloads in the database; retrieving each similar graph-based workload from the database, where each of the similar graph-based workloads is associated with a respective infrastructure subgraph corresponding to where that similar graph-based workload was executed; searching a large graph-based infrastructure topology for infrastructure subgraphs that are similar to the infrastructure subgraphs retrieved from the database, and retrieving a group of infrastructure subgraphs that collectively define a set of candidate nodes to run the new graph-based workload; filtering and ranking the set of candidate nodes according to a respective likelihood that the candidate nodes will satisfy requirements of the new graph-based workload; and assigning the new graph-based workload to one of the candidate nodes.

Embodiment 2. The method as recited in any preceding embodiment, wherein the graph-based workloads and the infrastructure graphs are represented by respective graph embeddings of their topologies.

Embodiment 3. The method as recited in any preceding embodiment, wherein the filtering and the ranking are performed using live telemetry data obtained from the candidate nodes.

Embodiment 4. The method as recited in any preceding embodiment, wherein the filtering and the ranking are performed using a lie-within relationship.

Embodiment 5. The method as recited in any preceding embodiment, wherein the searching of the large graph-based infrastructure topology, for the infrastructure subgraphs that are similar to the infrastructure subgraphs retrieved from the database, is performed using cosine distance information from embedded vectors that each correspond to a respective one of the infrastructure subgraphs.

Embodiment 6. The method as recited in any preceding embodiment, wherein the new graph-based workload is assigned to one of the candidate nodes using a “northwest corner” algorithm for capacity planning.

Embodiment 7. The method as recited in any preceding embodiment, wherein the assigning of the new graph-based workload to one of the candidate nodes comprises assessing a health status of the candidate nodes, and assessing a health status of network links between the candidate nodes, and the assessing of the health status of the candidate nodes and the network links is performed prior to assignment of the new graph-based workload.

Embodiment 8. The method as recited in any preceding embodiment, wherein the group of infrastructure subgraphs represents the graph topologies that are deemed likely to satisfy the requirements of the new graph-based workload.

Embodiment 9. The method as recited in any preceding embodiment, wherein the searching of the large graph-based infrastructure topology is based only on infrastructure sub-graph topologies.

Embodiment 10. The method as recited in any preceding embodiment, wherein the requirements of the new graph-based workload comprise hardware and/or software needed to execute the new graph-based workload.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### G. EXAMPLE COMPUTING DEVICES AND ASSOCIATED MEDIA

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

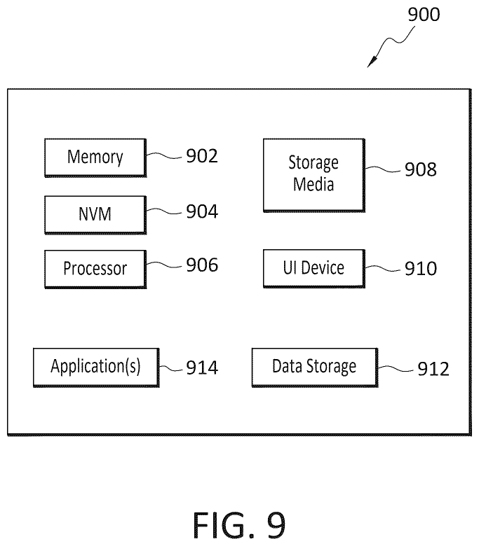

With reference briefly now to FIG. 9, any one or more of the entities disclosed, or implied, by FIGS. 1-8, and/or elsewhere herein, may take the form of, or include, or be implemented on, or hosted by, a physical computing device, one example of which is denoted at 900. As well, where any of the aforementioned elements comprise or consist of a virtual machine (VM), that VM may constitute a virtualization of any combination of the physical components disclosed in FIG. 9.

In the example of FIG. 9, the physical computing device 900 includes a memory 902 which may include one, some, or all, of random access memory (RAM), non-volatile memory (NVM) 904 such as NVRAM for example, read-only memory (ROM), and persistent memory, one or more hardware processors 906, non-transitory storage media 908, UI device 910, and data storage 912. One or more of the memory components 902 of the physical computing device 900 may take the form of solid state device (SSD) storage. As well, one or more applications 914 may be provided that comprise instructions executable by one or more hardware processors 906 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method, comprising:
maintaining a database of past executions of graph-based workloads and respective infrastructure graphs where the graph-based workloads were executed;
obtaining a graph embedding of a new graph-based workload and searching for similar graph-based workloads in the database;
retrieving each similar graph-based workload from the database, where each of the similar graph-based workloads is associated with a respective infrastructure subgraph corresponding to where that similar graph-based workload was executed;
searching a large graph-based infrastructure topology for infrastructure subgraphs that are similar to the infrastructure subgraphs retrieved from the database, and retrieving a group of infrastructure subgraphs that collectively define a set of candidate nodes to run the new graph-based workload;
filtering and ranking the set of candidate nodes according to a respective likelihood that the candidate nodes will satisfy requirements of the new graph-based workload; and
assigning the new graph-based workload to one of the candidate nodes.

2. The method as recited in claim 1, wherein the graph-based workloads and the infrastructure graphs are represented by respective graph embeddings of their topologies.

3. The method as recited in claim 1, wherein the filtering and the ranking are performed using live telemetry data obtained from the candidate nodes.

4. The method as recited in claim 1, wherein the filtering and the ranking are performed using a lie-within relationship.

5. The method as recited in claim 1, wherein the searching of the large graph-based infrastructure topology, for the infrastructure subgraphs that are similar to the infrastructure subgraphs retrieved from the database, is performed using cosine distance information from embedded vectors that each correspond to a respective one of the infrastructure subgraphs.

6. The method as recited in claim 1, wherein the new graph-based workload is assigned to one of the candidate nodes using a “northwest corner” algorithm for capacity planning.

7. The method as recited in claim 1, wherein the assigning of the new graph-based workload to one of the candidate nodes comprises assessing a health status of the candidate nodes, and assessing a health status of network links between the candidate nodes, and the assessing of the health status of the candidate nodes and the network links is performed prior to assignment of the new graph-based workload.

8. The method as recited in claim 1, wherein the group of infrastructure subgraphs represents the graph topologies that are deemed likely to satisfy the requirements of the new graph-based workload.

9. The method as recited in claim 1, wherein the searching of the large graph-based infrastructure topology is based only on infrastructure sub-graph topologies.

10. The method as recited in claim 1, wherein the requirements of the new graph-based workload comprise hardware and/or software needed to execute the new graph-based workload.

11. A non-transitory storage medium having stored therein instructions that are executable by one or more hardware processors to perform operations comprising:
maintaining a database of past executions of graph-based workloads and respective infrastructure graphs where the graph-based workloads were executed;
obtaining a graph embedding of a new graph-based workload and searching for similar graph-based workloads in the database;
retrieving each similar graph-based workload from the database, where each of the similar graph-based workloads is associated with a respective infrastructure subgraph corresponding to where that similar graph-based workload was executed;
searching a large graph-based infrastructure topology for infrastructure subgraphs that are similar to the infrastructure subgraphs retrieved from the database, and retrieving a group of infrastructure subgraphs that collectively define a set of candidate nodes to run the new graph-based workload;
filtering and ranking the set of candidate nodes according to a respective likelihood that the candidate nodes will satisfy requirements of the new graph-based workload; and
assigning the new graph-based workload to one of the candidate nodes.

12. The non-transitory storage medium as recited in claim 11, wherein the graph-based workloads and the infrastructure graphs are represented by respective graph embeddings of their topologies.

13. The non-transitory storage medium as recited in claim 11, wherein the filtering and the ranking are performed using live telemetry data obtained from the candidate nodes.

14. The non-transitory storage medium as recited in claim 11, wherein the filtering and the ranking are performed using a lie-within relationship.

15. The non-transitory storage medium as recited in claim 11, wherein the searching of the large graph-based infrastructure topology, for the infrastructure subgraphs that are similar to the infrastructure subgraphs retrieved from the database, is performed using cosine distance information from embedded vectors that each correspond to a respective one of the infrastructure subgraphs.

16. The non-transitory storage medium as recited in claim 11, wherein the new graph-based workload is assigned to one of the candidate nodes using a “northwest corner” algorithm for capacity planning.

17. The non-transitory storage medium as recited in claim 11, wherein the assigning of the new graph-based workload to one of the candidate nodes comprises assessing a health status of the candidate nodes, and assessing a health status of network links between the candidate nodes, and the assessing of the health status of the candidate nodes and the network links is performed prior to assignment of the new graph-based workload.

18. The non-transitory storage medium as recited in claim 11, wherein the group of infrastructure subgraphs represents the graph topologies that are deemed likely to satisfy the requirements of the new graph-based workload.

19. The non-transitory storage medium as recited in claim 11, wherein the searching of the large graph-based infrastructure topology is based only on infrastructure sub-graph topologies.

20. The non-transitory storage medium as recited in claim 11, wherein the requirements of the new graph-based workload comprise hardware and/or software needed to execute the new graph-based workload.
